(19) United States
(12) Patent Application Publication
(10) Pub. No.: US 2025/0365718 A1
(43) Pub. Date: Nov. 27, 2025

(54) METHODS FOR COMMUNICATION WITH A PLURALITY OF SECOND NODES VIA RESPECTIVE CHANNELS, RELATED FIRST NODES AND RELATED SECOND NODES

(71) Applicant: Sony Group Corporation, Tokyo (JP)

(72) Inventors: Jose FLORDELIS, Lund (SE); Fredrik RUSEK, Eslöv (SE); Chaitanya TUMULA, Åkarp (SE); Erik BENGTSSON, Eslöv (SE); Kun ZHAO, Malmö (SE); Olof ZANDER, Södra Sandby (SE)

(21) Appl. No.: 18/875,138

(22) PCT Filed: Jun. 30, 2023
(86) PCT No.: PCT/EP2023/068062

§ 371 Date: Dec. 14, 2024

(30) Foreign Application Priority Data
Jul. 12, 2022 (SE) 2250900-4

(51) Int. Cl. H04W 72/0453; H04L 27/26; H04W 72/0446

(52) U.S. Cl. CPC H04W 72/0453; H04L 27/2607; H04W 72/0446

(57) ABSTRACT

Disclosed is a method, performed by a first node, for communication with a plurality of second nodes via respective channels. The method comprises transmitting, to at least two second nodes of the plurality of second nodes, control signalling indicating that a frequency domain cyclic sequence associated with one or more data sets is used for the communication between the first node and one or both of the at least two second nodes.

The present disclosure pertains to the field of wireless communications. The present disclosure relates to a method for communication with a plurality of second nodes via respective channels, to related first nodes, and to related second nodes.

### BACKGROUND

A Time Domain Cyclic Prefix, TDCP, can be seen as a parameter necessary in Orthogonal Frequency-Division Multiplexing, OFDM, based systems, to, e.g., protect the signal intended to be transmitted against not only time-dispersive channels but also non-ideal time-synchronization at the receiver.

However, the TDCP does not provide any protection against non-ideal frequency-synchronization at the receiver or high Doppler channels. For this reason, frequency offsets, FOs, at the receiver side and high Doppler channels can be challenging in OFDM based systems. For example, widening the spectrum of a narrow-band signal transmitted through a multipath propagation channel may be detrimental to orthogonality. Thus, an advanced receiver may be required to cope with FOs and high Doppler channels, however with inherent performance degradations.

### SUMMARY

Due to a higher processing capability of a base station in comparison with a processing capability associated with wireless devices, the performance degradations incurred due to FO and high Doppler channels may become more severe for a DL transmission than for an UL transmission as a base station may adopt an advanced receiver to mitigate said impairments.

A Frequency Domain Cyclic Sequence, FDCS (such as a Frequency Domain Cyclic Prefix, FDCP) can be used to protect the signal intended to be transmitted against FOs and high Doppler channels. However, since some subcarriers may be allocated to the FDCS, the inclusion of the FDCS may incur a spectral efficiency loss.

Accordingly, there is a need for devices and methods, which may mitigate, alleviate, or address the shortcomings existing and may provide for an improved spectral efficiency.

Disclosed is a method, performed by a first node, for communication with a plurality of second nodes via respective channels. The method comprises transmitting, to at least two second nodes of the plurality of second nodes, control signalling indicating that a frequency domain cyclic sequence associated with one or more data sets is used for the communication between the first node and one or both of the at least two second nodes.

Further, a first node comprising memory circuitry, processor circuitry, and a wireless interface is provided. The first node is configured to perform any of the methods disclosed herein.

It is an advantage of the present disclosure that the disclosed method and disclosed first node may enable the use of a frequency domain cyclic sequence to cope with frequency offsets and high Doppler channels. In other words, the use of the frequency domain cyclic sequence may be beneficial to deal with variations in the propagation environment, such as relative movements, such as relative velocities, between a signal source and a destination, responsible for the time-variant nature of a radio channel.

It is an additional advantage of the present disclosure that the disclosed method and disclosed first node may enable the use of a joint frequency domain cyclic sequence (which is used for the communication between the first node and one or both of at least two second nodes) associated with one or more data sets. This can free resources since the number of subcarriers used to accommodate the FDCS can be reduced. Hence, improved spectral efficiency of the overall system may be achieved. This may be particularly advantageous in multi-user systems.

Disclosed is a method, performed by a second node, for communication with a first node. The method comprises receiving, from the first node, control signalling indicating that a frequency domain cyclic sequence associated with one or more data sets is used for communication between the first node and the second node. The second node is part of a plurality of second nodes.

Further, a second node comprising memory circuitry, processor circuitry, and a wireless interface is provided. The second node is configured to perform any of the methods disclosed herein.

It is an advantage of the present disclosure that the disclosed method and disclosed second node enables the first node to process the frequency domain cyclic sequence associated with one or more data sets transmitted by the first node. This allows the second node to cope with frequency offsets and high Doppler channels. It is an additional advantage of the present disclosure that the disclosed method and disclosed second node allow freeing resources since the number of subcarriers used to accommodate the FDCS can be reduced. Hence, improved spectral efficiency of the overall system may be achieved. This may be particularly advantageous in multi-user systems.

### BRIEF DESCRIPTION OF THE DRAWINGS

The above and other features and advantages of the present disclosure will become readily apparent to those skilled in the art by the following detailed description of examples thereof with reference to the attached drawings, in which:

FIG. 1 is a diagram illustrating an example wireless communication system according to this disclosure,

FIG. 2 is a signalling diagram illustrating an example communication between an example first node, and example second nodes according to this disclosure,

FIGS. 3A-3B show schematic diagrams of an example first node and an example second node acting as a transmitter and receiver, respectively, according to the disclosure,

FIG. 4 is a flow-chart illustrating an example method, performed by a first node, for communication with a plurality of second nodes via respective channels according to this disclosure,

FIG. 5 is a flow-chart illustrating an example method, performed by a first node, for communication with a plurality of second nodes via respective channels according to this disclosure,

FIG. 6 is a block diagram illustrating an example first node according to this disclosure, and

FIG. 7 is a block diagram illustrating an example second node according to this disclosure.

### DETAILED DESCRIPTION

Various examples and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the examples. They are not intended as an exhaustive description of the disclosure or as a limitation on the scope of the disclosure. In addition, an illustrated example needs not have all the aspects or advantages shown. An aspect or an advantage described in conjunction with a particular example is not necessarily limited to that example and can be practiced in any other examples even if not so illustrated, or if not so explicitly described.

The figures are schematic and simplified for clarity, and they merely show details which aid understanding the disclosure, while other details have been left out. Throughout, the same reference numerals are used for identical or corresponding parts.

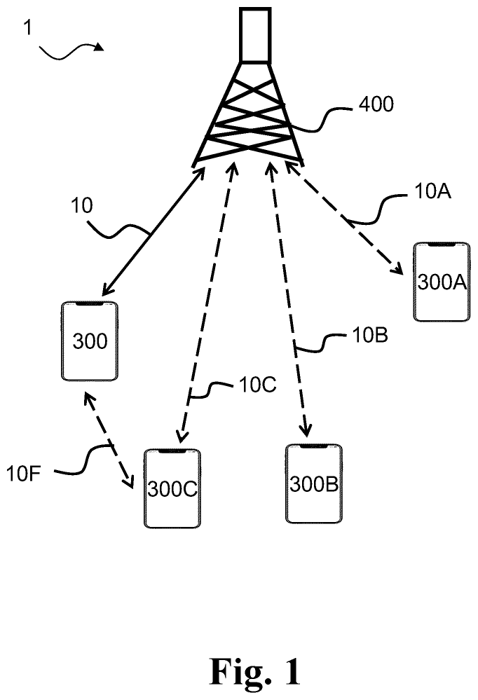

FIG. 1 is a diagram illustrating an example wireless communication system 1 according to this disclosure.

The wireless communication system 1 comprises one or more of: an example first node 400 and example second nodes 300, 300A, 300B.

As discussed in detail herein, the present disclosure relates to a wireless communication system 1 comprising a cellular system, for example, a 3GPP wireless communication system. The wireless communication system 1 may comprise one or more second nodes 300, 300A, 300B illustrated as wireless devices, and one or more first nodes 400 illustrated as a network node.

A first node disclosed herein may refer to a network node, such as a radio access network node operating in the radio access network, RAN, such as a base station, an evolved Node B, eNB, gNB in NR. In one or more examples, the RAN node is a functional unit which may be distributed in several physical units.

A second node may refer to a wireless device such as one or more of: a mobile device and a user equipment, UE.

In one or more examples, the first node is a network node while the second node is a wireless device.

The second nodes 300, 300A, 300B may be configured to communicate with the first node 400 via a wireless link (or radio access link) 10, 10A, 10B, 10C respectively.

In one or more examples, the first node is a first wireless device (such as 300C) while the second node is a second wireless device (such as 300), such as in sidelink communication. The first wireless device (such as 300C) may be configured to communicate with the second wireless device via a wireless link (or radio access link) 10F.

For example, the wireless link can be seen as a communication channel and/or a radio channel.

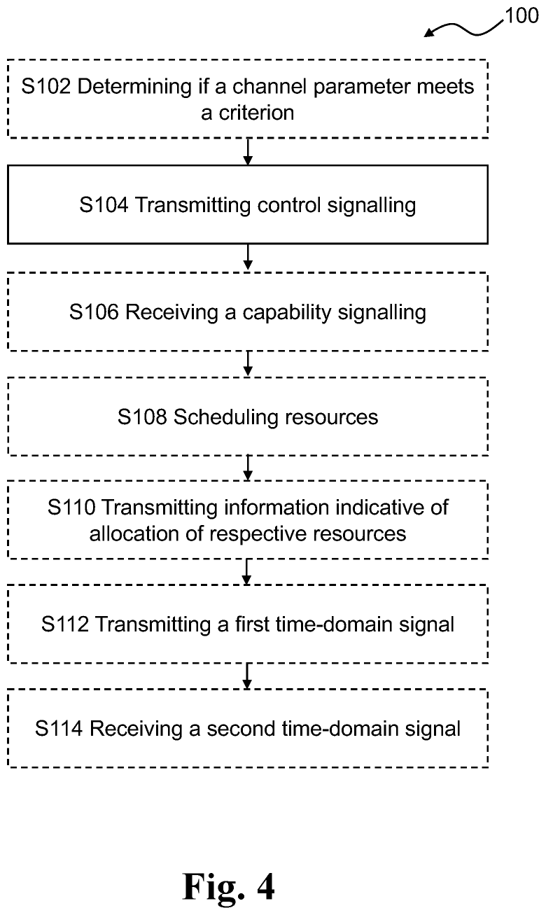

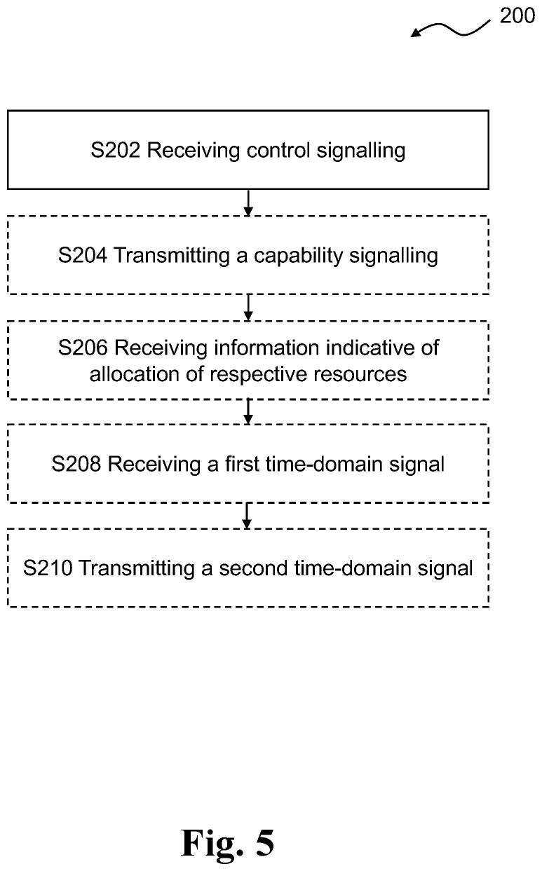

The first node is configured to perform the methods disclosed herein (such as in FIG. 4). The second node is configured to perform the methods disclosed herein (such as in FIG. 5).

Changes in the propagation environment, including changes in positions of a transmitter (e.g., first node) and a receiver (e.g., second node), are responsible for the time-variant nature of the channel between the transmitter and the receiver, and this is referred to as “Doppler effects”.

The channel between the first node and the second node may be of low delay spread type but with high Doppler. Approximately, the time-variant impulse response h(t, τ) consists of a single time variant tap. For example, a time-shift can be performed so that the only non-zero values occur for h(t, 0). In other words, a signal sent at time t is received at, and only at, time t with a time variant gain h(t)≡h(t, 0). Such channels are based on, for example, channel models from 3GPP specifications, (such as in TR 38.901 (version 17.0.0), [1, Section IV-A]). When transmissions involving multiple users (e.g., multiple wireless devices or multiple second nodes 300, 300A, 300B) are scheduled in the same OFDM symbols, e.g., using a Frequency Division Multiplexing scheme, then the resulting frequency-domain allocations may have a limited bandwidth comparable to the coherence bandwidth of the channel.

The present disclosure provides a frequency domain cyclic sequence (such as frequency domain cyclic prefix, FDCP) which may be used to deal with low delay spread and high Doppler channels, wherein the frequency domain cyclic sequence is generated based on one or more data sets (such as user data sets) destined to one or more second nodes (e.g., wireless devices, e.g., users). The one or more data sets may in some examples be destined to one or more second nodes respectively. Each of the one or more data sets may in some examples destined to each of the second nodes respectively. The one or more data set may all, in some examples be destined to the second nodes (e.g. many data set to all the second nodes).

When there is a single second node intending to receive, from the first node, a signal transmitted through a low delay spread and high Doppler channel, a frequency domain cyclic sequence is generated based on a corresponding data set, such as comprising data symbols. In other words, the first node transmits, to the second node, a pre-processed OFDM symbol in a time-domain (e.g., a time-domain signal) appending the FDCS at the beginning and/or the end of a frequency domain allocation of the pre-processed OFDM symbol, e.g. in the frequency domain. In other words, the pre-processed OFDM symbol in the time-domain results e.g. from applying an Inverse Fast Fourier Transform, IFFT, over the pre-processed OFDM symbol in the frequency domain (such as, the pre-processed OFDM symbol in a frequency domain) using the FDCS. Put differently, the pre-processed OFDM symbol in the frequency domain results e.g. from taking an additional Fast Fourier Transform, FFT, over the one or more data sets associated with the one or both of the at least two second nodes (e.g., a set of information symbols and/or modulation symbols and/or data symbols associated with each wireless device) followed by the insertion of the FDCS. The pre-processed OFDM symbol in the frequency domain may be seen as a Fast Fourier Transformed signal. The FDCS may be accommodated in resource elements, Res, (e.g., subcarriers comprising the pre-processed OFDM symbol in the frequency domain) at an end or beginning and/or at both end and beginning of the frequency domain allocation of the pre-processed OFDM symbol, e.g. in the frequency domain. The transmission of the D data symbols in one data set may require the allocation of D+L subcarriers which exacts a rate loss proportional to D/(D+L). Thus, L subcarriers may be reserved for the FDCS of the data set.

When there is a plurality of second nodes intending to receive a signal transmitted through a low delay spread and high Doppler channel, one approach may also be to use a frequency domain cyclic prefix, FDCP, per each second node. In other words, the first node transmits, to each second node, a pre-processed OFDM symbol in the time domain (such as, a time-domain signal), in which the pre-processed OFDM symbol in the time domain is the result of a parallel to serial operation of after performing, for each second and in parallel, the N-point IFFT, inserting the D data symbols at D contiguous subcarriers and adding a FDCS. Such approach may lead to a loss in the spectral efficiency since some subcarriers may be allocated to each FDCS generated and transmitted in each data set. The transmission of the DK data symbols, in which K data sets of D data symbols are intended to K second nodes (e.g., wireless devices, e.g., users), may require the allocation of K(D+L) subcarriers, with a total of LK subcarriers being reserved for the FDCSs.

The present disclosure provides a technique that enables including a joint FDCS for the plurality of second nodes. Stated differently, the first node transmits, to each second node, a pre-processed OFDM symbol in the time domain (such as a time-domain signal) including a FDCS associated with data sets destined to the plurality of second nodes. The inclusion of a joint FDCS for the plurality of second nodes may require each second node to receive in a wider bandwidth than what each second node is allocated to. The transmission of the DK data symbols may require the allocation of KD+L subcarriers, with a total of L subcarriers being reserved for the FDCS. The present disclosure supports the inclusion of the disclosed FDCS and provides control signalling informing each second node (e.g., each UE) that it needs to receive in a larger bandwidth than what had been necessary if the plurality of second nodes (e.g., the plurality of UEs) were served individually.

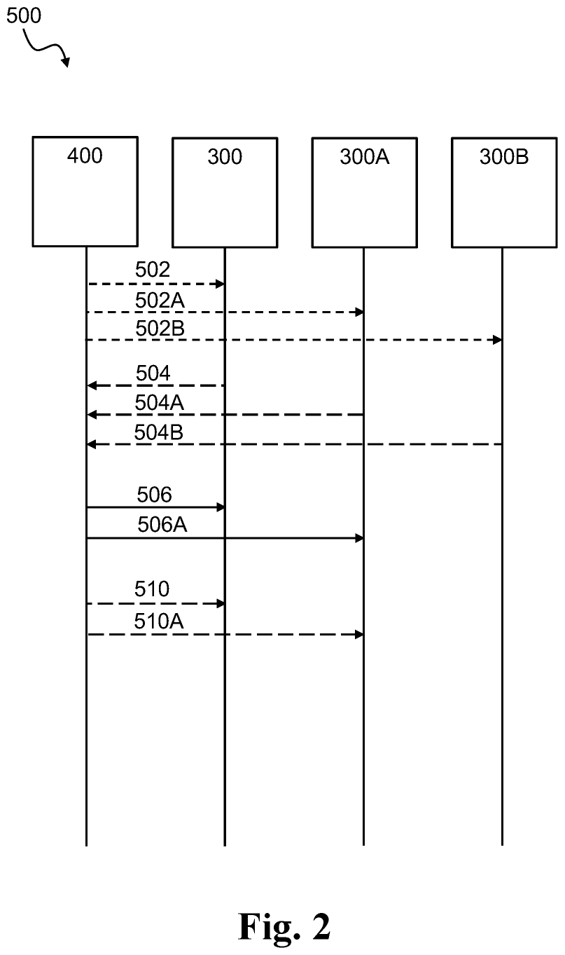

FIG. 2 is a signalling diagram 500 illustrating an example communication between an example first node 400, and example second nodes 300, 300A, 300B according to this disclosure.

The first node 400 transmits, to the at least two second nodes 300, 300A of the plurality of second nodes 300, 300A, 300B, control signalling 506, 506A indicating that a frequency domain cyclic sequence associated with one or more data sets is used for the communication between the first node 400 and one or both of the at least two second nodes 300, 300A. The control signalling 506, 506A indicates to the second nodes 300, 300A that a frequency domain cyclic sequence associated with one or more data sets is used for the upcoming communication from the first node 400 to the second nodes 300, 300A. This illustrates for example S104 of FIG. 4.

Before transmitting the control signalling 506, 506A, the first node 400 can measure and/or determine if a channel parameter of at least one of the respective channels meets a criterion (as illustrated e.g. in S102 of FIG. 4). The criterion may comprise a type of channel. In other words, the first node 400 determines the channel to each of the second nodes 300, 300A, 300B from the plurality of second nodes. The first node 400 may be able to obtain Channel State Information, CSI. For example, CSI Reference Signal (CSI-RS, such as periodic CSI-RS, semi-persistent CSI-RS, and/or aperiodic CSI-RS) transmissions may support the first node in acquiring CSI. The first node can thus determine when the channel parameter of at least one of the respective channels corresponding to each second node meets a criterion.

To measure the channel parameters, the first node 400 can transmit, to the at least two second nodes 300, 300A, 300B of the plurality of second nodes 300, 300A, 300B, reference signals 502, 502A, 502B (e.g. CSI-RS). The at least two second nodes 300, 300A, 300B can transmit, to the first node 400, feedback signals 504, 504A, 504B indicative of the channel parameter (such as CSI).

The first node 400 for example finds out based on the feedback signals 504, 504A that the channel parameter meets the criterion for second nodes 300, 300A. When the channel parameter meets the criterion, the first node can send control signalling 506, 506A to 300, 300A respectively and then sends, to 300 and 300A, time-domain signals 510, 510A including data sets and a joint FDCS to the corresponding second nodes. The time-domain signals 510, 510A can be seen as a downlink signals including the data sets and the joint FDCS when the first node 400 is a network node and the second nodes 300, 300A are wireless devices.

The first node 400 for example finds out based on the feedback signals 504B that the channel parameter does not meet the criterion for second node 300B. When the channel parameter does not meet the criterion, the corresponding second node 300B can be served by legacy methods. The legacy methods can include, for example, standard OFDM based techniques, implementing a time domain cyclic prefix, TDCP.

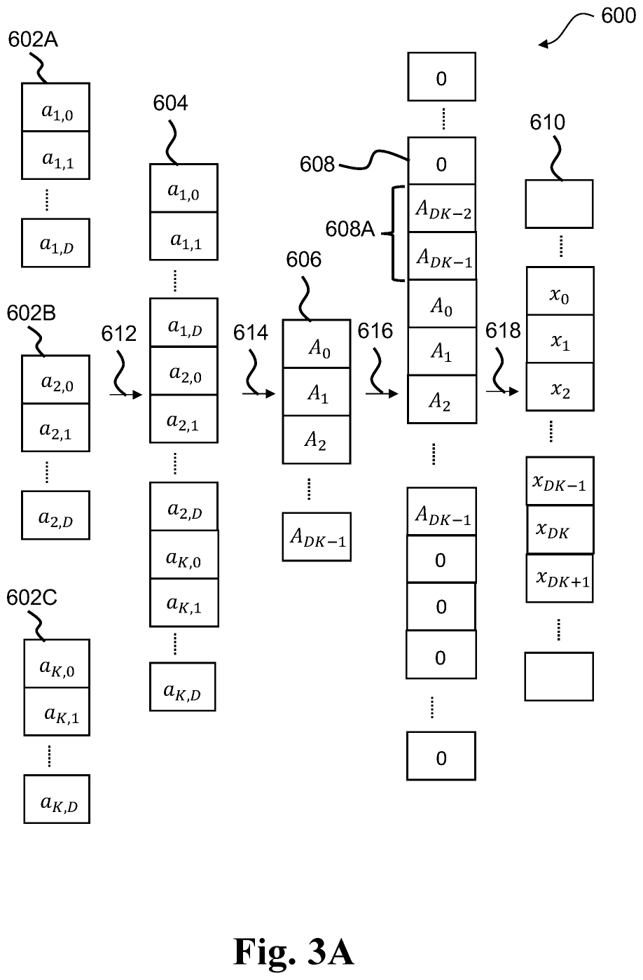

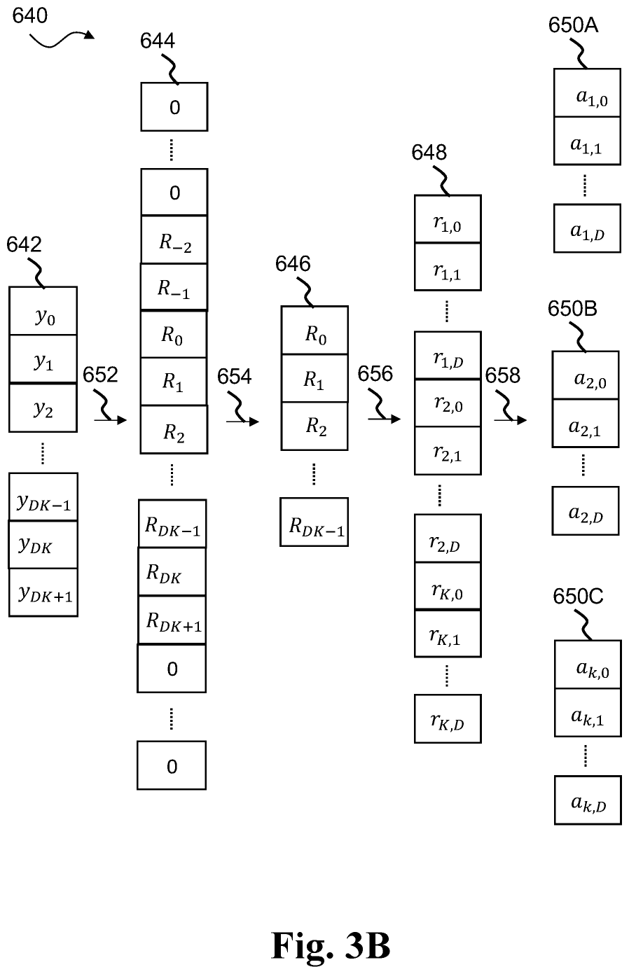

FIG. 3A-3C show schematic diagrams of an example first node and an example second node acting as a transmitter and receiver, respectively, according to the disclosure.

FIG. 3A shows a schematic diagram 600 of an example first node according to the disclosure.

The diagram 600 illustrates the steps performed by the first node when the first node is acting as the transmitter of the control signalling indicating that a FDCS associated with one or more data sets is used in an upcoming communication and of the time domain signal disclosed herein.

For example, a downlink transmission is illustrated with K second nodes, where each second node may be subject to a high Doppler and low delay-spread channel. The first node intends to transmit, to each second node of the K second nodes, a data set including D data symbols, aₖ=[a_{k,0} . . . a_{k,D-1}]^{T} for k=1, . . . , K.

The first node may intend to transmit, to each second node of the K second nodes, a data set 602A, 602B and 602C, respectively, with each data set comprising D data symbols. The DK data symbols may be concatenated and/or stacked and/or packed into a DK×1 vector 604, as illustrated after arrow 612. A DK-point Fast Fourier Transform, FFT, may be performed over the concatenated DK data symbols for provision of a first pre-processed OFDM symbol 606 in a frequency domain (such as, a first Fast Fourier Transformed symbol), as illustrated after arrow 614, which may be given by [A₀, A₁, . . . , A_{DK-1}]^{T}. The FFT operation can be seen as a conversion process from time domain to frequency domain. The data sets 602A, 602B and 602C for a first, second and K-th second node may be spread across DK×1 vector associated with the first pre-processed OFDM symbol 606 in the frequency domain. The DK data symbols associated with the K second nodes spread across the first pre-processed OFDM symbol 606 in the frequency domain may form part of an OFDM symbol to be transmitted over N subcarriers. In other words, the DK data symbols associated with the K second nodes spread across the first pre-processed OFDM symbol 606 in the frequency domain may be mapped into DK contiguous subcarriers. In one or more examples, the DK data symbols can be seen as occupying a set of the DK non-contiguous subcarriers.

A Frequency Domain Cyclic Sequence, FDCS, may be appended at an end and/or at a beginning of the frequency domain allocation of the first pre-processed OFDM symbol 606 in the frequency domain for provision of a first pre-processed OFDM symbol 608 in the frequency domain comprising the FDCS 608A.

The FDCS 608A can be of length L where L>fₘₐₓ/f_{Δ}, with f_{Δ} denoting the subcarrier spacing. Stated differently, the FDCS can be seen as the last L subcarriers from the set of the DK contiguous subcarriers, which can be used as a prefix. In a generic manner, fₘₐₓ can be seen as the maximum frequency deviation due to the combined effect of the Doppler shift and the Doppler spread. When the Doppler shift is compensated (e.g., at the receiver), then fₘₐₓ may be dominated by the Doppler spread and the Doppler spectrum may be typically contained in [−fₘₐₓ, fₘₐₓ].

For example, the length of the FDCS may be given by L=2, indicating that the data symbols and/or samples being carried by the last two subcarriers comprised in the frequency domain allocation of the first pre-processed OFDM symbol may also be two subcarriers from the set of N subcarriers (such as, A_{DK-1}, A_{DK-2})). The length of the FDCS may vary according to changes in positions of the transmitter and the receiver, including changes in the velocity of the transmitter and the receiver, such as changes associated with mobility environments. An increasing in the time-variant nature of the propagation environment requires a FDCS. The elements denoted as “0” indicate zero-values, such as subcarriers from the set of N subcarriers left unused.

Stated differently, not all the subcarriers are used for data transmission. Some subcarriers may be reserved for pilot signals (such as subcarriers used for channel estimation and equalization and/or to combat magnitude and phase errors at the receiver) and to act as a guard band (such as to reduce out of band, OOB, radiation, thus simplifying and/or reducing and/or easing the requirements on the front-end filters at the transmitter). A first time domain signal 610 may be generated by taking an N-point Inverse Fast Fourier Transformed, IFFT, as illustrated after arrow 618. For example, the IFFT operation can be seen as a conversion process from frequency domain to time domain. The first time domain signal 610 may be seen as a first pre-processed OFDM symbol in the time domain. In other words, first pre-processed OFDM symbol 606 in the frequency domain may be seen as a first primary pre-processed OFDM symbol which is FFT transformed and the first pre-processed OFDM symbol 610 in the time domain may be seen as a first secondary pre-processed OFDM symbol which is an IFFT transformation of the pre-processed OFDM symbol 608 comprising the FDCS 608A. The first pre-processed OFDM symbol 606 in the frequency domain may comprise the set of N subcarriers, with such subcarriers being used to carry either control information or information transmission.

The first time-domain signal 610, in which all samples and/or data symbols can be non-zero and resulting from the IFFT operation may be transmitted, to each second node from the plurality of K second nodes across a radio channel. In other words, the first time-domain signal 610 including the frequency domain cyclic prefix, FDCS, associated with the K data sets, with each data set comprising D data symbols, is transmitted across a radio channel to each second node from the plurality of K second nodes. In one or more examples, the first time domain signal 610 including the frequency domain cyclic prefix, FDCS, associated with the K data sets, with each data set comprising D data symbols, includes a TDCP.

FIG. 3B shows a schematic diagram 640 of example second nodes according to the disclosure.

The diagram 640 illustrates the steps performed by each second node when each second node is acting as a receiver of the control signalling disclosed herein and the time-domain signal disclosed herein.

For example, each second node receives, from the first node, a second time-domain signal 642 including a frequency domain cyclic sequence, FDCS, associated with K data sets, with each data set comprising D data symbols. In other words, the frequency domain cyclic sequence, FDCS is generated based on the K data sets 602A, 602B and 602C of FIG. 3A and appended to the K data sets 602A, 602B and 602C. The second time-domain signal 642 can be seen as a received time-domain signal by each second node. It may be envisioned that a same first time-domain signal, such as first time-domain signal 610, is sent by the first node to each second node. In other words, the first node sends to each second node the same first time-domain signal 610.

For example, sending the same first time-domain signal 610 sent to each second node does not imply receiving, by each second node, a second time-domain signal identical to the first time-domain signal 610. The first time-domain signal 610 and the second time-domain signal 642 may not be identical, due to the influence of the propagation characteristics associated with the radio channel on the first time-domain signal 610. For example, the second time-domain signal (such as 642) is a received version of the first time-domain signal (such as 610) which has been affected by the channel. The second time-domain signal 642 may be unique for each second node of the plurality of K second nodes. For example, the second time-domain signal 642 comprises N time samples. The N time samples are converted into the frequency domain using an N-point FFT for provision of a second Fast Fourier Transformed signal 644, as illustrated after arrow 652. Stated differently, the second time-domain signal 642 is converted into a frequency-domain signal, such as the second Fast Fourier Transformed signal 644. In one or more examples, the second time-domain signal 642 received includes a TDCP. In one or more examples, the second node removes the TDCP from the second time-domain signal 642 before taking the N-point FFT.

In absence of noise, some of the frequency samples may be zero valued. The number of non-zero frequency samples may exceed the number of non-zero frequency samples provided by the first pre-processed OFDM symbol 608 in the frequency domain comprising the FDCS 608A in FIG. 3A, due to the effect of the high Doppler channel, which is illustrated in FIG. 3C. Each second node from the plurality of K second nodes may extract DK frequency samples, such as DK subcarriers carrying DK data symbols (e.g., DK data bearing subcarriers), from the second Fast Fourier Transformed signal 644 for provision of a second OFDM symbol 646, as illustrated after arrow 654. In other words, each second node from the plurality of K second nodes may remove the frequency samples associated with the FDCS from the second Fast Fourier Transformed signal 644 and the exceeding frequency samples due to the high Doppler channel. The second OFDM symbol 646 may be converted into the time domain using a DK-point IFFT for provision of a second Inverse Fast Fourier Transformed signal 648, as illustrated after arrow 656. The second Inverse Fast Fourier Transformed signal 648 may comprise DK data symbols

$$r = [ {r}_{1}^{T} , {r}_{2}^{T} , … , {r}_{K}^{T} ] ,$$

where rₖ=[r_{k,0} . . . r_{k,D-1}]^{T}. In other words, the second Inverse Fast Fourier Transformed signal 648 can be seen as a second OFDM symbol that is processed by the second node in a manner that corresponds to the pre-processing of the first pre-processed OFDM symbol at the first node. Stated differently, the second Inverse Fast Fourier Transformed signal 648 may comprise the D data symbols associated with each second node of the plurality of K second nodes. The second Inverse Fast Fourier Transformed signal 648 may be properly separated allowing the K second nodes to extract and equalize the corresponding set of data symbols for provision of equalized data sets 650A, 650B, 650C for the respective K second nodes, as illustrated after arrow 658. The second Inverse Fast Fourier Transformed signal 648 may comprise the K data sets, each data set comprising D data symbols, which may be properly separated, allowing the K second nodes to extract and equalize the corresponding data set and recover the corresponding intended data set, such as the corresponding original data set.

It may be envisioned that, when comparing a single user system with a multi-user system, the loss in spectral efficiency reduces from D/(D+L) to D/(D+L/K).

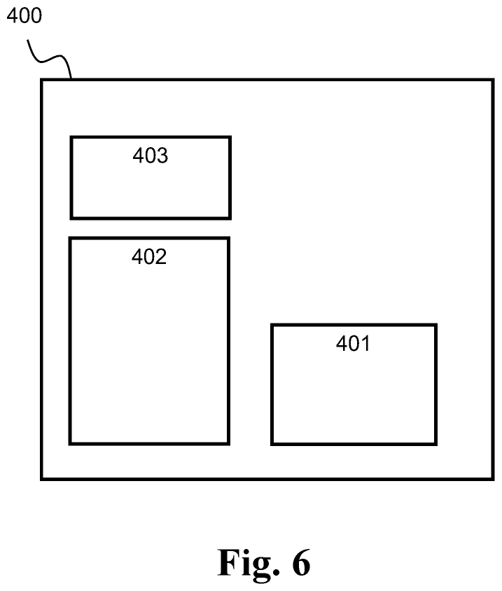

FIG. 4 is a flow-chart illustrating an example method 100, performed by a first node, for communication with a plurality of second nodes via respective channels, e.g. between each second node and the first node. The first node is the first node disclosed herein, such as first node 400 of FIG. 1, FIG. 2, and FIG. 6.

In one or more examples, the first node is a network node while the second node is a wireless device. In one or more examples, the first node is a first wireless device while the second node is a second wireless device. It may be particularly advantageous to deploy the disclosed method for channels that exhibit a certain behavior such as a channel showing a low delay spread, and/or a channel with high Doppler. The method 100 comprises transmitting S104, to at least two second nodes of the plurality of second nodes, control signalling indicating that a frequency domain cyclic sequence associated with one or more data sets is used for the communication between the first node and one or both of the at least two second nodes, such as one or more of the two second nodes. In other words, the first node transmits, to two second nodes, control signalling indicating that the frequency domain cyclic sequence, FDCS, associated with the one or more data sets is used for the communication between the first node and one or both second nodes. The control signalling indicating that the FDCS is used for an upcoming communication between the first node and one or both second nodes for example informs the second nodes that an FDCS is going to be used or inserted in an upcoming transmission of a signal from the first node to the second nodes. The second nodes may need to prepare for a particular processing of the upcoming signal to reap the benefits of the FDCS. The control signalling indicating that the FDCS is used for an upcoming communication allows the second nodes to know how to receive and process the upcoming communication that would include the FDCS disclosed herein. This is for example illustrated in FIG. 2 with control signalling 506, 506A, and the signals and OFDM symbols at the first node and at the second node in FIGS. 3A-B respectively.

The FDCS is associated with one or more data sets in that the FDCS is determined based on the one or more data sets. In one or more examples, the FDCS can be seen as being a common or joint FDCS for data sets. The FDCS is generated and inserted in a signal to provide reliability and robustness of the signal. For example, the FDCS can act as a guard band between successive symbols to overcome any impairments, such as inter-symbol interference.

The frequency domain cyclic sequence, FDCS, can be seen as an affix. For example, the FDCS can be a prefix. In some examples, FDCS can be a suffix. Stated differently, the FDCS can be inserted at an end and/or at a beginning and/or at both the end and the beginning of the one or more data sets to be communicated.

A data set can be seen as second node specific data set, such as a user specific data set, such as a wireless device specific data set. In other words, the pre-processed OFDM symbol may comprise one or more data sets, wherein each data set is associated with a corresponding second node of a plurality of second nodes, and a joint frequency domain cyclic sequence, FDCS. The data set can be seen as a set of information symbols and/or data symbols and/or modulation symbols. Stated differently, the data set can be seen as a set of complex values representing a mapped constellation point and therefore specifying both an amplitude and a phase of a sinusoid for a subcarrier. A data set includes for example one or more symbols resulting from performing a Fast Fourier transform, FFT. For example, the FDCS can be inserted as illustrated as A_{DK}−2 and A_{DK}−1 in FIG. 3A. The data sets may be grouped, and the grouped data sets may be seen as a group comprising the data sets associated with the plurality of second nodes which are stacked into a single vector prior to performing the FFT operation. The FDCS is determined based on the one or more data sets of the group. In one or more examples, the FDCS can be seen as being a common or joint FDCS for a plurality of data sets.

The frequency domain cyclic sequence associated with the one or more data sets may be seen as a cyclic prefix, such as a frequency domain cyclic prefix. The FDCS is associated with one or more data sets, in that the FDCS is calculated based on the data of the one or more data sets. The FDCS can be seen as a FDCP.

The frequency domain cyclic sequence associated with the one or more data sets can be seen as a cyclic structure existing within a pre-processed OFDM symbol in the time domain. The pre-processed OFDM symbol in the time domain may be seen as a time-domain signal, such as time-domain signal 610 from FIG. 3A, for communication between the first node and one or both of the at least two second nodes. A pre-processed OFDM symbol (such as a frequency domain signal) results from taking an additional Fast Fourier Transform, FFT, over the one or more data sets associated with the one or both of the at least two second nodes, followed by the insertion of the FDCS.

In one or more examples, transmitting S104 comprises transmitting, to at least two second nodes of the plurality of second nodes, control signalling indicating that a frequency domain cyclic sequence associated with one or more data sets is used for the communication between the first node and one or more of the at least two second nodes. In other words, the control signalling is for example transmitted from the first node to the two second nodes to indicate that a FDCS associated with one or more data set is used for the communication between the first node and one or more of the two second nodes.

The control signalling may be as control signalling 506, 506A illustrated in FIG. 2. The control signalling indicating that a frequency domain cyclic sequence associated with one or more data sets is used for the communication between the first node and one or both of the at least two second nodes can be in form of a flag and/or one or more control messages. For example, the flag may be seen as an implicit signalling indicating to the one or both of the at least two second nodes the use of the frequency domain cyclic sequence associated with one or more data sets. The one or more control messages can indicate to the one or both of the at least two second nodes the use of the frequency domain cyclic sequence associated with one or more data sets. The one or more control messages can include information indicating to the one or both of the at least two second nodes the use of the frequency domain cyclic sequence associated with one or more data sets.

In one or more example methods, the method 100 comprises determining S102 if a channel parameter of at least one of the respective channels meets a criterion. In one or more example methods, the transmission S104 of the control signalling is performed upon determining that the channel parameter meets the criterion. In one or more example methods, the criterion comprises a type of channel. For example, the channel parameter can include one or more of: a delay spread, a Doppler spectrum, a Doppler spread, a Doppler shift and a power-delay profile.

The type of channel may include a low delay spread and high Doppler channel. Stated differently, the channel between the first node and the plurality of second nodes may be a low delay spread and high Doppler channel.

S102 can for example involve transmission by the first node of reference signals (such as 502, 502A, 502B of FIG. 2) and reception by the first node of feedback signals (such as 504, 504A, 504B of FIG. 2).

For example, when the first node determines that the channel parameter meets the criterion, the first node transmits, to at least two second nodes of the plurality of second nodes, the control signalling indicating that a frequency domain cyclic sequence associated with one or more data sets is used for the communication between the first node and one or both of the at least two second nodes.

When the first node determines that the channel parameter does not meet the criterion, such as that the channel between the first node and a second node from the plurality of second nodes is not of the low delay spread and high Doppler type, the first node transmits, to the corresponding second node, control signalling indicating a different transmission configuration to overcome the impairments imposed by another type of channel. Stated differently, when the first node determines that the channel parameter does not meet the criterion, such as that the channel between the first node and a second node from the plurality of second nodes is not of the low delay spread and high Doppler type, the corresponding second node may be served by legacy methods. For example, the legacy methods can include, for example, standard OFDM based techniques, implementing a time domain cyclic prefix, TDCP, only.

As illustrated in FIG. 2, when the channel associated with a second node is not of low delay spread and high Doppler type, the second node may be served by legacy methods, such as standard OFDM based techniques, implementing time domain cyclic prefixes.

In one or more example methods, the control signalling comprises static signalling and/or semi-static signalling, and/or dynamic signalling. In one or more example methods, the control signalling is part of a Radio Resource Control, RRC, layer, a Medium Access Control, MAC, layer and a Physical, PHY, layer. In other words, the control signalling indicating that a frequency domain cyclic sequence associated with one or more data sets may be transmitted to the second node using one or more of: a Radio Resource Control, RRC, layer, a Medium Access Control, MAC, layer and a Physical, PHY, layer.

The control signalling may be transmitted via the RRC, as part of the static signalling and/or semi-static, such as using a control channel. The RRC may provide the plurality of second nodes with information indicative of allocation of resources such as information to setup the OFDM subcarriers and the bandwidths associated with the plurality of second nodes. In other words, the RRC may set up predefined subcarriers to be allocated to the plurality of second nodes for transmission of data.

The control signalling may be transmitted via the MAC layer to the PHY layer, being transmitted using a Physical Downlink Channel. The control signalling may be transmitted via Downlink Control Information, DCI, as part of the dynamic signalling, being transmitted on the Physical Downlink Control Channel, PDCCH at the PHY layer. The DCI may provide the plurality of second nodes with information such as physical layer resource allocation and/or the use of the FDCS disclosed herein. Stated differently, the DCI may provide the plurality of second nodes with information indicative of allocation of resources, such as information indicating a dynamic selection of the OFDM subcarriers and/or the use of the FDCS disclosed herein. The DCI may be used to activate the use of the FDCS associated with one or more data sets. It may be envisioned that the use of DCI reduces the amount of signalling needed to perform such activation in conjunction with the dynamic selection of the OFDM subcarriers used to carry the data associated with the at least two second nodes.

In one or more example methods, the method 100 comprises receiving S106, from at least one second node of the plurality of second nodes, capability signalling indicative of a capability of the at least one second node to support the frequency domain cyclic sequence associated with a plurality of data sets. In other words, the capability signalling indicates, for example, to the first node whether the second node is capable of supporting the frequency domain cyclic sequence associated with the plurality of data sets. S106 can be performed after S104 as an accept of the second node indicating that the second node can support the disclosed FDCS in upcoming communications. In some examples, S106 can be performed before S104 in that the second node informs the first node of the second node's capability of supporting the FDCS disclosed herein. For example, a wireless device acting as a second node can send a capability signalling to a network node acting as a first node, indicating that the wireless device supports or does not support the frequency domain cyclic sequence associated with the plurality of data sets, such as before the FDCS is inserted in a signal sent from the first node to the second node.

The capability signalling may indicate a capability according to which the at least one second node of the plurality of second nodes is not capable of processing the FDCS associated with the one or more data sets to be transmitted by the first node. The capability signalling may indicate a capability according to which the at least one second node of the plurality of second nodes is capable of processing FDCS associated with the one or more data sets to be transmitted by the first node.

The capability of the at least one second node of the plurality of second nodes to support the FDCS may be seen as a capability to support the modulation format used with the FDCS. In other words, the second node needs to post process the time-domain signal with the FDCS, transmitted by the first node, with both an FFT and an Inverse Fast Fourier Transform, IFFT, for provision of demodulated data. For example, the capability of the second node to support the FDCS disclosed herein may be part of a default feature introduced in a particular Release of the 3GPP standard. The insertion of the FDCS disclosed herein may be used for a certain period, by activating and deactivating the insertion of the FDCS and the control signalling thereof. In some examples, the insertion of the FDCS disclosed can be performed by the first node for any succeeding data to be communicated with the second node(s). For example, the insertion of the FDCS disclosed can be for a few seconds, e.g. 5 s, which would affect around 70 000 OFDM symbols, at 15 kHz subcarrier spacing.

In one or more example methods, the method 100 comprises scheduling S108, optionally based on the capability signalling, resources for serving the plurality of second nodes using a joint frequency domain cyclic sequence. For example, a network node acting as first node schedules resources for serving wireless devices as second nodes in an upcoming communication, where the network node uses the joint FDCS in the upcoming communication to the wireless devices. For example, the first node schedules subcarriers to transmit the joint FDCS associated with the data sets, along with the data sets in a time-domain signal(s).

In one or more example methods, the method 100 comprises transmitting S110, to each second node, information indicative of allocation of respective resources to each corresponding second node. In one or more example methods, the respective resources are in a time domain. In one or more example methods, the information comprises a time-domain reference signal. In one or more example methods, the time-domain reference signal comprises a time-domain demodulation reference signal, TD-DMRS. For example, the first node informs each second node about the time-domain resources allocated to each corresponding second node. It may be required from the second the first node to transmit, to each second node of the plurality of second nodes, information indicating which OFDM subcarriers are required to be extracted in the frequency domain, such as the OFDM subcarriers used for carrying its own data set. The first node may also need to provide each second node of the plurality of second nodes information indicating which part in the first time-domain signal corresponds to each second node. For example, the TD-DMRS may be an indicator to ensure that each second node can decode its corresponding data set. The TD-DMRS may be inserted in the data sets corresponding to each second node, such as data sets 602A, 602B, 602C of FIG. 3A, to be extracted by each second node during an equalization process, allowing for a robust decoding of the corresponding data set. The equalization process comprises performing an equalization technique by an equalizer. For example, the equalizer can be a one tap per subcarrier equalizer, such as a one tap zero-forcing (ZF) equalizer and/or minimum mean-square error (MMSE) equalizer.

In one or more example methods, the method 100 comprises transmitting S112, to each second node of the plurality of second nodes, a first time-domain signal including the frequency domain cyclic sequence associated with the data sets. For example, the first time-domain signal includes the data sets and the FDCS associated with the data sets. For example, when the first node acts as a network node and the second nodes act as wireless devices, the first time-domain signal is a downlink signal including the data sets and the FDCS associated with the data sets. For example, in a sidelink communication between a first wireless device acting as a first node and a second wireless device acting as a second node, the first wireless device may collect and/or receive the data sets that are to be transmitted to the second wireless devices, and may generate and transmit the first time-domain signal as a sidelink signal including the data sets and the FDCS associated with the data sets.

The first time-domain signal including the frequency domain cyclic sequence associated with the data sets can be seen as a signal resulting from the first pre-processed OFDM symbol (e.g. first time-domain signal 610 of FIG. 3A that results from the first pre-processed OFDM symbol 608 of FIG. 3A). The first time-domain signal may result from the implementation of an IFFT over the transformed data sets including the FDCS associated with the data sets (such as the data sets transformed by the FFT such as 608 illustrated in FIG. 3A). Stated differently, the IFFT can modulate the data sets and the FDCS associated with the data sets onto a number of orthogonal subcarriers, such as the subcarriers reserved to serve the plurality of second nodes comprised in the control signalling. The first time-domain signal resulting from the IFFT operation may be transmitted across a radio channel. The transmission to each second node of the plurality of second nodes of a first time-domain signal including the data sets and the frequency domain cyclic sequence associated with the data sets may be seen as a downlink transmission.

In one or more example methods, the communication is over a bandwidth that is based on the number of second nodes in the plurality of second nodes. In one or more example methods, the control signalling comprises information indicative of the bandwidth. Each second node of the plurality of second nodes may receive the first time-domain signal including the data sets and the joint frequency domain cyclic sequence. The first time-domain signal may comprise the corresponding data sets associated to the at least two second nodes of the plurality of second nodes and frequency domain cyclic sequence, as illustrated in FIG. 3A. Stated differently, each second node may receive a time-domain signal, such as the second time-domain signal, comprising data sets associated with other second nodes, such as 642 of FIG. 3B. Each second node may need to receive the second time-domain signal in a larger bandwidth, such as a bandwidth that is based on the number of second nodes in the plurality of second nodes. Each second node may need to obtain information indicative of the bandwidth to be able to decode its own data set in a manner illustrated in FIG. 3B, such as data set 650A, 650B, 650C of FIG. 3B. In other words, each second node of the plurality of second nodes receiving the second time-domain signal from the first node may require information indicative of the entire bandwidth, including the location of the corresponding signal, such as a time duration.

In one or more example methods, the method 100 comprises receiving S114, from the at least one second node, a second time-domain signal including the frequency domain cyclic sequence associated with the data set. For example, the second time-domain signal includes the data set and the FDCS associated with the data set. For example, when the first node acts as a network node and the second nodes act as wireless devices, the second time-domain signal is an uplink signal including the data set and the FDCS associated with the data set. The second time-domain signal including the frequency domain cyclic sequence associated with the data set can be seen as a signal resulting from an OFDM symbol associated with a single data set. Stated differently, the OFDM symbol for transmission from the second node may be associated with a second node from the plurality of second nodes. The reception of the second time-domain signal including the frequency domain cyclic sequence associated with the data set can be seen as an uplink transmission. This may be readily illustrated in FIG. 3A when considering only one data set, such as 602A of FIG. 3A.

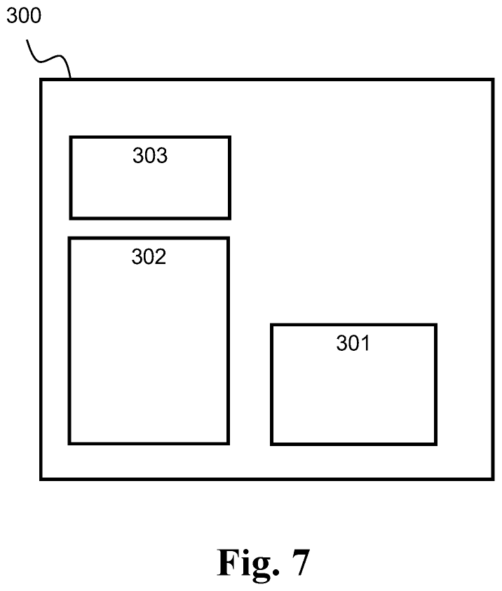

FIG. 5 is a flow-chart of an example method 200, performed by a second node according to the disclosure, for communication with a first node, such as the first node 400. The second node is the second node disclosed herein, such as second node 300, 300A, 300B, 300C of FIG. 1, FIG. 2, and FIG. 7.

In one or more examples, the first node is a network node while the second node is a wireless device. In one or more examples the first node is a first wireless device while the second node is a second wireless device. It may be particularly advantageous to deploy the disclosed method for channels that exhibit a certain behavior such as a channel showing a low delay spread, and/or a channel with high Doppler.

A Frequency Domain Cyclic Sequence, FDCS (such as a Frequency Domain Cyclic Prefix, FDCP) can be used to protect the signal intended to be transmitted, e.g., against FOs and high Doppler channels.

The method 200 comprises receiving S202, from the first node, control signalling indicating that a frequency domain cyclic sequence associated with one or more data sets is used for communication between the first node and the second node. The second node is part of a plurality of second nodes. For example, the first node receives control signalling transmitted in S104 of FIG. 4. In other words, the second node receives, from the first node, control signalling indicating that the frequency domain cyclic sequence, FDCS, associated with the one or more data sets is used for the communication between the first node and the second node. The control signalling indicating that the FDCS is used for an upcoming communication between the first node and the second node for example informs the second node that an FDCS is going to be used in an upcoming transmission of a signal from the first node to the second node. The second node may need to prepare for a particular processing of the upcoming signal to reap the benefits of the FDCS. This is for example illustrated in FIG. 2 with control signalling 506, 506A, and the signals and OFDM symbols at the first node and at the second node in FIGS. 3A-B respectively.

The FDCS is associated with one or more data sets in that the FDCS is determined based on the one or more data sets. In one or more examples, the FDCS can be seen as being a common or joint FDCS for data sets destined to second nodes. The FDCS is generated and inserted in a signal to provide reliability and robustness of the signal. For example, the FDCS can act as a guard band between successive symbols to overcome any impairments, such as inter-symbol interference.

In one or more example methods, the control signalling comprises static signalling and/or semi-static signalling, and/or dynamic signalling.

In one or more example methods, the control signalling is part of Radio Resource Control layer and/or Medium Access Control layer and/or Physical layer.

In one or more example methods, the method 200 comprises transmitting S204, to the first node, capability signalling indicative of a capability of the second node to support the frequency domain cyclic sequence associated with a plurality of data sets. For example, the second node, transmits capability signalling received in S106 of FIG. 4.

In one or more example methods, the method 200 comprises receiving S206, from the first node, information indicative of allocation of a resource for the second node. In one or more example methods, the resource is in a time domain. This may correspond to S110 of FIG. 4.

In one or more example methods, the information comprises a time-domain reference signal.

In one or more example methods, the time-domain reference signal comprises a time-domain demodulation reference signal, TD-DMRS.

In one or more example methods, the method 200 comprises receiving S208, from the first node, a first time-domain signal including the frequency domain cyclic sequence associated with the plurality of data sets. This may correspond to S112 of FIG. 4. This may be seen as a downlink signal including the data sets and a corresponding joint FDCS when the first node is a network node, and the second nodes are wireless devices.

In one or more example methods, the method 200 comprises transmitting S210, to the first node, a second time-domain signal including the frequency domain cyclic sequence associated with the data set. This may correspond to S114 of FIG. 4. This may be seen as an uplink signal including the data set and a corresponding joint FDCS when the first node is a network node, and the second nodes are wireless devices.

In one or more example methods, the communication is over a bandwidth that is based on the number of second nodes in the plurality of second nodes.

FIG. 6 shows a block diagram of an example first node 400 according to the disclosure. The first node 400 comprises memory circuitry 401, processor circuitry 402, and a wireless interface 403. The first node 400 may be configured to perform any of the methods disclosed in FIG. 4. In other words, the first node 400 may be configured for communication with a plurality of second nodes via respective channels, e.g. between each second node and the first node.

The first node 400 is configured to communicate with a plurality of second nodes via respective channels, such as the first node disclosed herein, using a wireless communication system.

The first node 400 is configured to transmit (such as via the wireless interface 403), to at least two second nodes of the plurality of second nodes, control signalling indicating that a frequency domain cyclic sequence associated with one or more data sets is used for the communication between the first node and one or both of the at least two second nodes.

The wireless interface 403 is configured for wireless communications via a wireless communication system, such as a 3GPP system, such as a 3GPP system supporting one or more of: New Radio, NR, Narrow-band IoT, NB-IoT, and Long Term Evolution-enhanced Machine Type Communication, LTE-MTC, Non-Terrestrial Network, NTN, Non-Terrestrial Network IoT, NTN-IoT, millimeter-wave communications, such as millimeter-wave communications in licensed bands and unlicensed bands, such as device-to-device millimeter-wave communications in licensed bands.

Processor circuitry 402 is optionally configured to perform any of the operations disclosed in FIG. 4 (such as any one or more of S102, S106, S108, S110, S112, S114). The operations of the first node 400 may be embodied in the form of executable logic routines (for example, lines of code, software programs, etc.) that are stored on a non-transitory computer readable medium (for example, memory circuitry 401) and are executed by processor circuitry 402.

Furthermore, the operations of the first node 400 may be considered a method that the first node 400 is configured to carry out. Also, while the described functions and operations may be implemented in software, such functionality may also be carried out via dedicated hardware or firmware, or some combination of hardware, firmware and/or software.

Memory circuitry 401 may be one or more of a buffer, a flash memory, a hard drive, a removable media, a volatile memory, a non-volatile memory, a random access memory (RAM), or other suitable device. In a typical arrangement, memory circuitry 401 may include a non-volatile memory for long term data storage and a volatile memory that functions as system memory for processor circuitry 402. Memory circuitry 401 may exchange data with processor circuitry 402 over a data bus. Control lines and an address bus between memory circuitry 401 and processor circuitry 402 also may be present (not shown in FIG. 6). Memory circuitry 401 is considered a non-transitory computer readable medium.

Memory circuitry 401 may be configured to store how to process the FDCS in a part of the memory.

FIG. 7 shows a block diagram of an example second node 300 according to the disclosure. The second node 300 comprises memory circuitry 301, processor circuitry 302, and a wireless interface 303. The second node 300 may be configured to perform any of the methods disclosed in FIG. 5. In other words, the second node 300 may be configured for communication with a first node.

The second node 300 is configured to communicate with a first node, such as the second node disclosed herein, using a wireless communication system.

The second node 300 is configured to receive (such as via the wireless interface 303), from the first node, control signalling indicating that a frequency domain cyclic sequence associated with one or more data sets is used for communication between the first node and the second node. The second node is part of a plurality of second nodes.

The wireless interface 303 is configured for wireless communications via a wireless communication system, such as a 3GPP system, such as a 3GPP system supporting one or more of: New Radio, NR, Narrow-band IoT, NB-IoT, and Long Term Evolution-enhanced Machine Type Communication, LTE-MTC, Non-Terrestrial Network, NTN, Non-Terrestrial Network IoT, NTN-IoT, millimeter-wave communications, such as millimeter-wave communications in licensed bands and unlicensed bands, such as device-to-device millimeter-wave communications in licensed bands.

The second node 300 is optionally configured to perform any of the operations disclosed in FIG. 5 (such as any one or more of S204, S206, S208, S210). The operations of the second node 300 may be embodied in the form of executable logic routines (for example, lines of code, software programs, etc.) that are stored on a non-transitory computer readable medium (for example, memory circuitry 301) and are executed by processor circuitry 302.

Furthermore, the operations of the second node 300 may be considered a method that the second node 300 is configured to carry out. Also, while the described functions and operations may be implemented in software, such functionality may also be carried out via dedicated hardware or firmware, or some combination of hardware, firmware and/or software.

Memory circuitry 301 may be one or more of a buffer, a flash memory, a hard drive, a removable media, a volatile memory, a non-volatile memory, a random access memory (RAM), or other suitable device. In a typical arrangement, memory circuitry 301 may include a non-volatile memory for long term data storage and a volatile memory that functions as system memory for processor circuitry 302. Memory circuitry 301 may exchange data with processor circuitry 302 over a data bus. Control lines and an address bus between memory circuitry 301 and processor circuitry 302 also may be present (not shown in FIG. 7). Memory circuitry 301 is considered a non-transitory computer readable medium.

Memory circuitry 301 may be configured to store how to process the FDCS in a part of the memory.

Examples of methods and products (first node and second node) according to the disclosure are set out in the following items:

Item 1. A method, performed by a first node, for communication with a plurality of second nodes via respective channels, the method comprising:
transmitting (S104), to at least two second nodes of the plurality of second nodes, control signalling indicating that a frequency domain cyclic sequence associated with one or more data sets is used for the communication between the first node and one or both of the at least two second nodes.

Item 2. The method according to item 1, wherein the control signalling comprises static signalling and/or semi-static signalling, and/or dynamic signalling.

Item 3. The method according to any of the previous items, wherein the control signalling is part of Radio Resource Control layer and/or Medium Access Control layer and/or Physical layer.

Item 4. The method according to any of the previous items, the method comprising:
receiving (S106), from at least one second node of the plurality of second nodes, capability signalling indicative of a capability of the at least one second node to support the frequency domain cyclic sequence associated with a plurality of data sets.

Item 5. The method according to item 4, the method comprising:
scheduling (S108), based on the capability signalling, resources for serving the plurality of second nodes using a joint frequency domain cyclic sequence.

Item 6. The method according to any of the previous items, the method comprising:
transmitting (S110), to each second node, information indicative of allocation of respective resources to each corresponding second node, wherein the respective resources are in a time domain.

Item 7. The method according to item 6, wherein the information comprises a time-domain reference signal.

Item 8. The method according to item 7, wherein the time-domain reference signal comprises a time-domain demodulation reference signal, TD-DMRS.

Item 9. The method according to any of the previous items, the method comprising:
transmitting (S112), to each second node of the plurality of second nodes, a first time-domain signal including the frequency domain cyclic sequence associated with the data sets.

Item 10. The method according to any of the previous items, the method comprising:
receiving (S114), from the at least one second node, a second time-domain signal including the frequency domain cyclic sequence associated with the data set.

Item 11. The method according to any of the previous items, wherein the communication is over a bandwidth that is based on the number of second nodes in the plurality of second nodes, and wherein the control signalling comprises information indicative of the bandwidth.

Item 12. The method according to any of the previous items, the method comprising:
determining (S102) if a channel parameter of at least one of the respective channels meets a criterion,
wherein the transmission of the control signalling is performed upon determining that the channel parameter meets the criterion.

Item 13. The method according to item 12, wherein the criterion comprises a type of channel.

Item 14. A method, performed by a second node, for communication with a first node, the method comprising:
receiving (S202), from the first node, control signalling indicating that a frequency domain cyclic sequence associated with one or more data sets is used for communication between the first node and the second node, wherein the second node is part of a plurality of second nodes.

Item 15. The method according to item 14, wherein the control signalling comprises static signalling and/or semi-static signalling, and/or dynamic signalling.

Item 16. The method according to any of items 14-15, wherein the control signalling is part of Radio Resource Control layer and/or Medium Access Control layer and/or Physical layer.

Item 17. The method according to any of items 14-16, the method comprising:
transmitting (S204), to the first node, capability signalling indicative of a capability of the second node to support the frequency domain cyclic sequence associated with a plurality of data sets.

Item 18. The method according to any of items 14-17, the method comprising:
receiving (S206), from the first node, information indicative of allocation of a resource for the second node, wherein the resource is in a time domain.

Item 19. The method according to item 18, wherein the information comprises a time-domain reference signal.

Item 20. The method according to item 19, wherein the time-domain reference signal comprises a time-domain demodulation reference signal, TD-DMRS.

Item 21. The method according to any of items 14-20, the method comprising:
receiving (S208), from the first node, a first time-domain signal including the frequency domain cyclic sequence associated with the plurality of data sets.

Item 22. The method according to any of items 14-21, the method comprising:
transmitting (S210), to the first node, a second time-domain signal including the frequency domain cyclic sequence associated with the data set.

Item 23. The method according to any of items 14-22, wherein the communication is over a bandwidth that is based on the number of second nodes in the plurality of second nodes.

Item 24. A first node comprising memory circuitry, processor circuitry, and a wireless interface, wherein the first node is configured to perform any of the methods according to any of items 1-13.

Item 25. A second node comprising memory circuitry, processor circuitry, and a wireless interface, wherein the second node is configured to perform any of the methods according to any of items 14-23.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that Figures comprise some circuitries or operations which are illustrated with a solid line and some circuitries, components, features, or operations which are illustrated with a dashed line. Circuitries or operations which are comprised in a solid line are circuitries, components, features, or operations which are comprised in the broadest example. Circuitries, components, features, or operations which are comprised in a dashed line are examples which may be comprised in, or a part of, or are further circuitries, components, features, or operations which may be taken in addition to circuitries, components, features, or operations of the solid line examples. It should be appreciated that these operations need not be performed in order presented. Furthermore, it should be appreciated that not all of the operations need to be performed. The example operations may be performed in any order and in any combination. It should be appreciated that these operations need not be performed in order presented. Circuitries, components, features, or operations which are comprised in a dashed line may be considered optional.

Other operations that are not described herein can be incorporated in the example operations. For example, one or more additional operations can be performed before, after, simultaneously, or between any of the described operations.

Certain features discussed above as separate implementations can also be implemented in combination as a single implementation. Conversely, features described as a single implementation can also be implemented in multiple implementations separately or in any suitable sub-combination. Moreover, although features may be described above as acting in certain combinations, one or more features from a claimed combination can, in some cases, be excised from the combination, and the combination may be claimed as any sub-combination or variation of any sub-combination

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the examples may be implemented at least in part by means of both hardware and software, and that several “means”, “units” or “devices” may be represented by the same item of hardware.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than or equal to 10% of, within less than or equal to 5% of, within less than or equal to 1% of, within less than or equal to 0.1% of, and within less than or equal to 0.01% of the stated amount. If the stated amount is 0 (e.g., none, having no), the above recited ranges can be specific ranges, and not within a particular % of the value.

The various example methods, devices, nodes, and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

1. A method, performed by a first node, for communication with a plurality of second nodes via respective channels, the method comprising:
transmitting, to at least two second nodes of the plurality of second nodes, control signalling indicating that a frequency domain cyclic sequence associated with one or more data sets is used for the communication between the first node and one or both of the at least two second nodes.

2. The method according to claim 1, wherein the control signalling comprises static signalling and/or semi-static signalling, and/or dynamic signalling;
wherein the control signalling is part of Radio Resource Control layer and/or Medium Access Control layer and/or Physical layer.

3. The method according to claim 1, the method comprising:
receiving, from at least one second node of the plurality of second nodes, capability signalling indicative of a capability of the at least one second node to support the frequency domain cyclic sequence associated with a plurality of data sets.

4. The method according to claim 3, the method comprising:
scheduling, based on the capability signalling, resources for serving the plurality of second nodes using a joint frequency domain cyclic sequence.

5. The method according to claim 1, the method comprising:
transmitting, to each second node, information indicative of allocation of respective resources to each corresponding second node, wherein the respective resources are in a time domain.

6. The method according to claim 5, wherein the information comprises a time-domain reference signal.

7. The method according to claim 6, wherein the time-domain reference signal comprises a time-domain demodulation reference signal (TD-DMRS).

8. The method according to claim 1, the method comprising:
transmitting, to each second node of the plurality of second nodes, a first time-domain signal including the frequency domain cyclic sequence associated with the data sets.

9. The method according to claim 1, the method comprising:
receiving, from the at least one second node, a second time-domain signal including the frequency domain cyclic sequence associated with the data set.

10. The method according to claim 1, wherein the communication is over a bandwidth that is based on the number of second nodes in the plurality of second nodes, and wherein the control signalling comprises information indicative of the bandwidth.

11. The method according to claim 1, the method comprising:
determining if a channel parameter of at least one of the respective channels meets a criterion,
wherein the transmission of the control signalling is performed upon determining that the channel parameter meets the criterion.

12. The method according to claim 11, wherein the criterion comprises a type of channel.

13. A method, performed by a second node, for communication with a first node, the method comprising:
receiving, from the first node, control signalling indicating that a frequency domain cyclic sequence associated with one or more data sets is used for communication between the first node and the second node, wherein the second node is part of a plurality of second nodes.

14. The method according to claim 13, wherein the control signalling comprises static signalling and/or semi-static signalling, and/or dynamic signalling; wherein the control signalling is part of Radio Resource Control layer and/or Medium Access Control layer and/or Physical layer.

15. The method according to claim 13, the method comprising:
transmitting, to the first node, capability signalling indicative of a capability of the second node to support the frequency domain cyclic sequence associated with a plurality of data sets.

16. The method according to claim 13, the method comprising:
receiving, from the first node, information indicative of allocation of a resource for the second node, wherein the resource is in a time domain.

17. The method according to claim 16, wherein the information comprises a time-domain reference signal.

18. The method according to claim 17, wherein the time-domain reference signal comprises a time-domain demodulation reference signal (TD-DMRS).

19. The method according to claim 13, the method comprising:
receiving, from the first node, a first time-domain signal including the frequency domain cyclic sequence associated with the plurality of data sets.

20. The method according to claim 13, the method comprising:
transmitting, to the first node, a second time-domain signal including the frequency domain cyclic sequence associated with the data set.
